(19) United States
(12) Patent Application Publication
(10) Pub. No.: US 2013/0066643 A1
(43) Pub. Date: Mar. 14, 2013

(54) CONFIGURABLE MEDICAL FINDING PREDICTION SYSTEM AND METHOD

(71) Applicants: James B. Seward, Rochester, MN (US); William H. Hansen, Rochester, MN (US)

(72) Inventors: James B. Seward, Rochester, MN (US); William H. Hansen, Rochester, MN (US)

(21) Appl. No.: 13/409,899

(22) Filed: Mar. 1, 2012

Related U.S. Application Data
(63) Continuation-in-part of application No. 12/578,325, filed on Oct. 13, 2009.
(60) Provisional application No. 61/447,957, filed on Mar. 1, 2011.

(51) Int. Cl. G06Q 50/22

(52) U.S. Cl. 705/2

(57) ABSTRACT

A reconfigurable medical decision support system for processing medical data of a patient includes a data processing system that receives the medical data of the patient and accesses a knowledge-base. The knowledge-base includes a feature set relating to a pathophysiological condition. The feature set has a plurality of associated features, each feature having a plurality of validated quantifiable stages, each assigned a score. The medical data is associated with features of the feature-set. A medical risk value is determined based on the modified validated quantifiable stage and the assigned score. A medical finding is determined from the knowledge base corresponding to the medical risk value. An output statement stored in the knowledge-base and associated with the medical finding is provided. The user is able to modify values of the validated quantifiable stages and modify the output statements.

### CROSS-REFERENCE TO RELATED APPLICATIONS

This application claims priority to and the benefit of, Provisional U.S. Patent Application Ser. No. 61/447,957, filed on Mar. 1, 2011, entitled “Configurable Medical Finding Prediction System and Method”, and is a continuation-in-part application of U.S. application Ser. No. 12/578,325 filed on Oct. 13, 2009 entitled “Automated Management of Medical Data Using Expert Knowledge and Applied Complexity Science for Risk Assessment and Diagnoses”, the disclosures of which are incorporated herein by reference in their entireties.

### BACKGROUND

1. Field of the Invention

The present disclosure generally relates to healthcare services, and more particularly to a configurable medical finding prediction system.

2. Description of Related Art

Diagnostic testing of patients, such as echocardiographic exam, is an information-intensive endeavor and benefits from the application of biomedical informatics approaches and resources and typically results in a variety of patient data and data points. A Clinical/Computer Decision Support System (“CDSS”) simplifies access and analysis of patient data that is needed to make decisions. A CDSS is an interactive decision support system that is generally used to assist physicians and other health and medical professionals, generally referred to herein as “clinicians” with evaluating patient medical data diagnosis decisions. Patient data, such as the results of diagnostic testing, is inputted into the CDSS, and the CDSS will generally provide suggestions for the clinician to evaluate. A CDSS can also provide data reminders and prompts, assists in defining a likely diagnosis, help acquire accurate or additional data and alert the clinician when diagnostic patterns are recognized. A knowledge-based CDSS includes rules and the associations of compiled data, which are typically in the form of “IF-THEN” rules. The rules from the knowledge-base are combined with the data from the patient to generate diagnosis decision suggestions. The clinician typically inputs the patient data into the CDSS, and allows the CDSS to generate one or more possible diagnosis decision choices. The clinician can then act on the suggestion or choices.

The Food and Drug Administration (FDA) is charged with device regulation. Up to now, many stand-alone CDSS have been exempt from FDA device regulation because they required “competent human intervention” between the advice derived from the CDSS and actual patient intervention. The role of the computer within the CDSS is to enhance and support the clinician who is ultimately responsible for clinical decisions and medical treatment options for the patient. The intent of a CDSS is to assist the clinician in decision-making and in doing so the CDSS must allow the user to personally configure local standards without comprising the decision-making processes.

Present medical finding prediction systems recognize that software is most accurately regarded as a human mental construct, i.e., the sort of thing, which is not customarily a regulatory issue. User primacy must be assured because of the complex and dynamic nonlinear nature of disease processes and a continuously evolving knowledge base. Software evolves rapidly and locally and is virtually impossible for predicting needs and changes at the initial introduction of a CDSS. Clinical decision-making is imperfect. Continuous clinical DSS improvement and refinement must be the standard to be striven for and met.

Maintenance of a knowledge base is critical to the clinical validity of a CDSS. A successful CDSS cannot survive unless the medical knowledge bases supporting them are kept current. Users, not systems, need to characterize and solve clinical diagnostic problems. As a part of this validation process, new cases must be analyzed with the CDSS on a regular basis (regression testing). In addition, periodic rerunning of previous test cases must be run on a regular basis, to verify that there has not been significant “drift” in either the knowledge base or the diagnostic program that would influence the system's abilities. Tolerance of change must be embraced and continuously maintained. With large patient populations and a myriad of diagnoses imbedded in the knowledge base, conducting prospective clinical trials, to demonstrate that the system works for all ranges of diagnostic problems and variety of patients with each diagnosis, would require enrollment of huge numbers of patients and would cost millions of dollars. Because a state-of-the-art CDSS continuously changes, regulation would be virtually impossible. Thus, it behooves the vendor to insure the active participation of the user in configuring and validating the decision-making processes.

The classic CDSS provides information to users that rely solely on the credibility of algorithms upon which the system is based. However, there is a clear need for the user to be able to reconfigure the CDSS to conform to local or specific clinical needs or standards which may deviate in some manner from published guidelines and standards.

Accordingly, it would be desirable to provide a system that addresses at least some of the problems identified above.

### SUMMARY OF THE INVENTION

As described herein, the exemplary embodiments overcome one or more of the above or other disadvantages known in the art.

One aspect of the exemplary embodiments relates to a reconfigurable medical decision support system for processing medical data of a patient. In one embodiment, the system includes a data processing system with a memory in communication with a processor, the memory including program instructions for execution by the processor to receive the medical data, access a knowledge-base data set stored therein, the knowledge-base including a feature set relating to a pathophysiological condition, the feature set having a plurality of associated features, each feature having a plurality of validated quantifiable stages and each validated quantifiable stage being assigned a score, associate the medical data with features of the feature-set, detect a request to modify a value of a validated quantifiable stage associated with a feature, verify the request and modify the validated quantifiable stage to create a modified validated quantifiable stage, associate the score from the validated quantifiable stage with the modified validated quantifiable stage, determine a medical risk value based on the modified validated quantifiable stage and the assigned score, determine a medical finding from the knowledge base corresponding to the medical risk value, associate an output statement stored in the knowledge-base with the medical finding, and a user interface for providing the output statement.

Another aspect of the disclosed embodiments relates to a computer program product. In one embodiment, the computer program product includes computer readable program code means for evaluating medical data of a person to determine a medical finding, the computer readable program code means when executed in a processor device, being configured to, obtain the medical data of the person, access a medical knowledge-base data set stored in a memory, the knowledge-base including a feature set relating to a pathophysiological condition, the feature set having a plurality of associated features, each feature having a plurality of validated quantifiable stages and each validated quantifiable stage being assigned a score, enable a user to reconfigure a value associated with a validated quantifiable stage associated with a feature, associate the medical data with features of a feature-set from the knowledge-base, determine an association between the medical data and the quantifiable stages associated with the feature corresponding to the medical data, determine scores corresponding to the association of the medical data and quantifiable stages, determine a medical risk value based on the scores corresponding to the association of the medical data and quantifiable stages, determine a medical finding from the knowledge-base corresponding to the medical risk value, and provide an output statement corresponding to the medical finding.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and unless otherwise indicated, they are merely intended to conceptually illustrate the structures and procedures described herein.

### BRIEF DESCRIPTION OF THE DRAWINGS

In the drawings:

FIG. 1 is a schematic block diagram of one embodiment of a configurable diagnostic decision support and medical finding prediction system incorporating aspects of the present disclosure;

FIG. 2 is a schematic block diagram of another embodiment of a configurable diagnostic decision support and medical finding prediction system incorporating aspects of the present disclosure;

FIG. 3 illustrates one embodiment of an exemplary user interface for a configurable diagnostic decision support and medical finding prediction system incorporating aspects of the present disclosure;

FIG. 4 illustrates one embodiment of an exemplary user interface for a configurable diagnostic decision support and medical finding prediction system incorporating aspects of the present disclosure;

FIG. 5 illustrates one embodiment of an exemplary user interface for a configurable diagnostic decision support and medical finding prediction system incorporating aspects of the present disclosure;

FIG. 6 illustrates one embodiment of an exemplary user interface for a configurable diagnostic decision support and medical finding prediction system incorporating aspects of the present disclosure;

FIGS. 7 and 8 illustrate exemplary algorithmic models used in a non-configurable clinical decision support system of the prior art;

FIGS. 9 and 10 illustrate exemplary algorithmic models for use in a configurable diagnostic decision support and medical finding prediction system incorporating aspects of the present disclosure;

FIG. 11 is a flowchart illustrating one embodiment of a method in a configurable diagnostic decision support and medical finding prediction system incorporating aspects of the present disclosure;

FIG. 12 is a flowchart illustrating one embodiment of modifying a validated quantifiable stage value in a medical finding prediction system incorporating aspects of the present disclosure; and

FIG. 13 is a flowchart illustrating one embodiment of modifying an output statement associated with a medical finding in a medical finding prediction system incorporating aspects of the present disclosure.

### DETAILED DESCRIPTION OF THE INVENTION

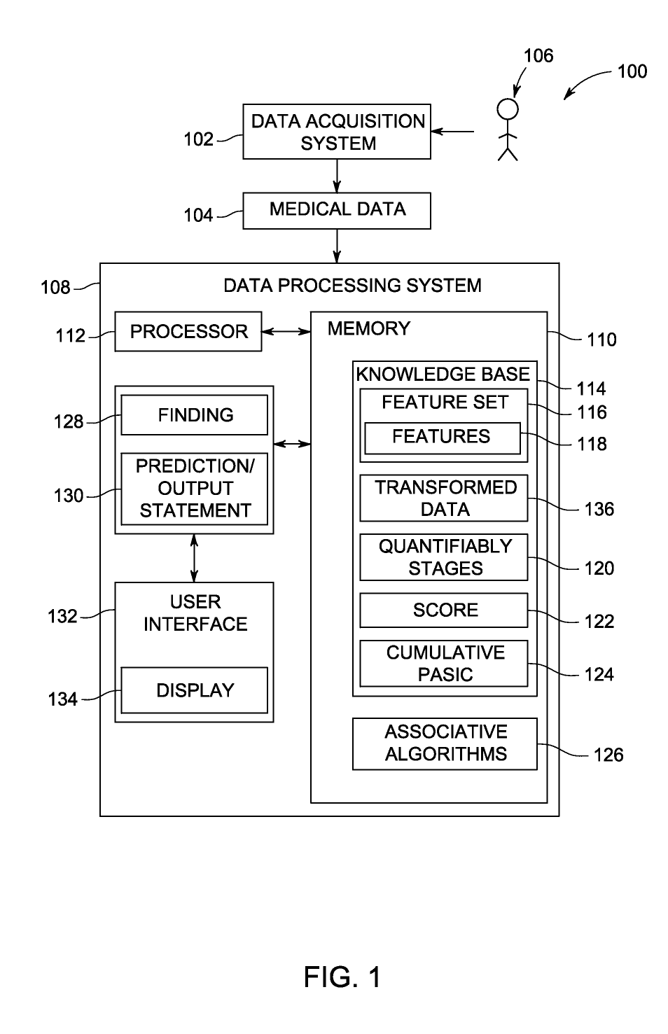

Referring to FIG. 1, an exemplary configurable or reconfigurable diagnostic decision support and medical finding prediction system 100 incorporating aspects of the present disclosure is shown. In operation, the diagnostic decision support and medical finding prediction system of the disclosed embodiments generally comprises a dynamically layered clinical/computer decision support system (CDSS) that provides automated decision support to assist healthcare providers in the screening, evaluation and diagnoses of medical or disease conditions. The diagnostic decision support and medical finding prediction system 100 of the disclosed embodiments is configurable, or reconfigurable, and will generally be referred to herein as a “configurable medical prediction system.” The aspects of the disclosed embodiments allow users to reconfigure key inputs and outputs of the configurable medical finding prediction system's knowledge based algorithms. This function allows users of a pre-determined algorithm to directly influence the data ranges and output expressions without adversely affecting the power of the decision making process. The aspects of the disclosed embodiments assure the user's dominant role in the decision making processes of the configurable medical finding prediction system 100.

As is illustrated in FIG. 1, in one embodiment, the exemplary configurable medical finding prediction system 100 includes a medical data acquisition system or tool 102 and a data processing system 108. Although the data acquisition tool 102 is shown as a stand-alone device in FIG. 1, in one embodiment, the data acquisition tool 102 is integrated into the data processing system 108.

The data acquisition system 102 is configured to obtain or acquire medical and diagnostic data of a person 106, also referred to herein as a “patient.” The medical and diagnostic data 104, generally referred to as “medical data”, can generally include any patient examination results or data, and diagnostic information and parametric, which reflect a physiological state or condition of the patient 106. Examples of the medical data 104 can include for example, but are not limited to, vital sign data, electrocardiogram (ECG) data, laboratory and examination results, diagnostic test data and diagnostic imaging data, etc. In alternate embodiments, the medical data 104 can include any health or diagnostic data related to or otherwise associated with the patient 106.

The source of the medical data 104 that is obtained by the data acquisition tool 102 and/or provided to the data processing system 108 can include any suitable diagnostic device or system that is configured to obtain physiological and other medical related information and data of a patient. Examples of these types of devices and systems can include, but are not limited to, clocks, timers, blood pressure monitors, electrocardiogram (ECG) monitors, echocardiogram and Doppler devices, ultrasound systems, magnetic resonance (MR) systems, computer tomography (CT) systems, positron emission tomography (PET) systems, ventilation monitors, blood analysis devices, drug and fluid dispensing devices, blood sugar monitors, temperature monitors, telemetry units, pulse oximetry devices, diagnostic imaging devices, electronic medical records, plans of care, disease templates and protocols, etc. In alternate embodiments, the source of the medical data 104 obtained by the data acquisition tool 102 can include any suitable source of medical data and health related information. The data acquisition tool 102 is configured to obtain the medical data 104 in any suitable or known fashion. In one embodiment, the data acquisition tool 102 includes or is communicatively coupled to one or more of the sources of the medical data 104. For example, the data acquisition tool 102 can receive diagnostic data directly from a diagnostic device such as a sonogram or x-ray system, in the form of a data transfer or download. Alternatively, the data acquisition tool 102 can access or obtain the medical data 104 from a memory storage device or system that is used to store the medical data 104, such as a health information processing and storage system or device or electronic medical record. In one embodiment, the medical data 104 can also be manually inputted by the clinician to the data acquisition tool 102. The aspects of the disclosed embodiments are not intended to be limited by the manner in which the data acquisition tool 102 obtains the medical data and other health related information for processing in the system 100. In one embodiment, the data acquisition tool 102 is part of a hospital data or medical record network or such other suitable medical record and information network, and is configured to receive and transmit data and information, as well as store such information. The data acquisition tool 102 can also include one or more processors comprised of or including machine-readable instructions that are executable by a processing device.

In the embodiment shown in FIG. 1, the data acquisition tool 102 is communicatively coupled to the data processing system 108. The data processing system 108 is configured to receive and process the medical data 104 and provide outputs, or expressions of outputs that can be used by the clinician in evaluating the medical data 104 and generating a diagnosis. In the embodiment shown in FIG. 1, the data processing system 108 generally comprises a memory 110, a processor 112 and a user interface 132. The user interface 132 includes or is coupled to an output or display device 134. The display device 134 can also comprise an audio component. In one embodiment, the user interface 132 and display device 134 comprises a single interface between the data processing system 108 and the user or clinician. Although the memory 110, processor 112 and user interface 132 are shown as being part of the same device, in alternate embodiment each could be part of a separate device or system.

In one embodiment, the data processing system 108 is configured to receive the medical data 104 directly from the data acquisition tool 102 in the form of stored medical data, images or record, such as an x-ray or sonogram. In one embodiment, the medical data 104 can be stored in the memory 110. The memory 110 generally includes, but is not limited to read only memory (ROM), random-access memory (RAM) and/or solid state memory. The memory 110 may also include one or more mass storage devices such as a floppy or other removable disk drive, a hard disk drive, a direct access storage device (DASD), an optical drive e.g., a compact disk (CD) drive, a digital video disk (DVD) drive, etc., and/or a tape drive, among others, and/or a combination of one or more devices described herein.

In the embodiment shown in FIG. 1, the memory 110 includes a main storage of the computer, as well as any supplemental levels of memory, e.g., cache memories, nonvolatile and/or backup memories, programmable or flash memories, portable memories, other read-only memories, etc. In addition, the memory 110 can include memory storage physically located elsewhere but in communication with the data processing system 108. An example of such memory 110 includes a distributed or “cloud computing” data storage scheme wherein data is stored on another computer coupled to the system 108 via a network.

While the memory 110 is shown conceptually in FIG. 1 as a single monolithic entity, it is well known that memory is often arranged in a hierarchy of caches and other memory devices, some or all of which may be integrated into the same semiconductor substrate as the processor 112.

In one embodiment, the processor 112 is comprised of machine-readable instructions that are executable by a processing device. Although a single processor 112 is shown in FIG. 1, it will be understood that computer systems having multiple central or other processing units could be used.

In the embodiment shown in FIG. 1, the memory 110 includes or stores a knowledge-base 114. The knowledge-base 114 generally comprises the medical community's validated knowledge and includes one or more feature-sets 116, where each feature set relates to a particular physiological or medical condition. The knowledge-base 114 catalogs and validates morphologic, physiologic and biologic data as features 116, characterizes natural physiological conditions and events and establishes the feature-sets 118 of features 116 matched to specific diseases and/or specific or general risks. Each feature-set 116 represents a general or specific medical condition which may be a disease surrogate or a hub, each having a small number or group of highly associated features that characterize that particular medical condition. The knowledge-base 114 generally contains validated experts' knowledge of these medical conditions. In one embodiment, the knowledge-base 114 comprises a computer storage medium or database on which the medical community's validated knowledge and data, including feature-sets 116 and features 118 are stored.

Each feature-set 116 has a plurality of highly associated, multivariable data or features 118. In one embodiment, a feature-set 116 will include a number of data items that is greater than one, preferably two to four, but generally less than or equal to ten. In alternate embodiments, any suitable number of data items, or features 118, can be included.

Each feature 118 has one or more validated quantifiable stages 120. A quantifiable stage 120 is a value, or range of values, that correspond to a numerical indication of the particular feature. Features 118 are generally characterized by specific health and medical signs or other quantifiable data. For example, for the feature 118 of “ejection fraction” included in a feature set 116 related to “heart failure”, the quantifiable stages 120 can include different ejection fracture measurement data points or ranges. As an example, the quantifiable stages 120 for the “ejection fraction” feature 118 in this example could include (i) ≧55%, (ii) 45-54%, (iii) 31-44% and (iv) ≦30%. Thus, an ejection fraction measurement of 40% would fall in the quantifiable stage of 31-44%. The aspects of the disclosed embodiments, as is described further herein, allow user of the system 100 to modify the values that make up each of the quantifiable stages 120.

The aspects of the disclosed embodiments will identify those feature-set(s) 116 that have the highest correlation of features 118 with the inputted medical data 104 of the patient 106. In one embodiment, at least two data points of the medical data 104 must correlate with at least two of the features 118 of each of the features in a feature-set 116. In this way, the medical data 104 is transformed into subsets of feature-sets 116, also referred to as a transformed data set 136. The subsets of feature-sets 116 are formed from the knowledge of the features 118 of the medical data to metadata in the form of the groups of associated features 118, where each group forms a subset of feature sets 116 for a particular disease pathology. Examples of the formation of transformed data sets are described in commonly owned U.S. patent application Ser. Nos. 12/578,325 filed on Oct. 13, 2009 and 12/710,983 filed on Feb. 23, 2010.

A score 122 is assigned to each quantifiable stage 120. The score 122 will generally correspond to a medical risk associated with the particular quantifiable stage 120. In this example, the scores 122 are generally numerical, where higher score values are generally indicative of a higher medical risk or degree of expression. In alternate embodiments, any suitable score or ranking system can be used, including a textual scoring system. In a textual scoring system, numerical values can be associated with each word score.

Table 1 below provides an exemplary list of features 118. One or more of the features 118 can be part of or included in a feature set 116. For example, for a feature-set 116 that is a surrogate disease model associated with heart failure, the features 118 could include, but are not limited to, ejection fraction, chronicity, acuities of filling pressures, myocardial relaxation. Each feature 118 is associated with one or more quantifiable stages 120, and each quantifiable stage 120 is assigned a numerical score 122.

In the example of Table I, the first column lists the features 118. The second column is a list of knowledge base validated quantifiable stages 120. The third column lists the assigned numerical score 122 related to a particular knowledge base validated quantifiable stage 120.

TABLE 1

| FEATURE | QUANTIFIABLE STAGES | | SCORE |
|---|---|---|---|
| (118) | (120) | | (122) |
| Age | ≧75 | years | 3 |
| | 45-74 | years | 2 |
| | 16-44 | years | 1 |
| | Fetal | | 2 |
| | Infant | | 2 |
| Body mass index | 18.5-24.9 | | 0 |
| | 25-30 | | 1 |
| | 30-35 | | 2 |
| | >35 | | 3 |
| Systolic blood pressure | <120 | mm Hg | 0 |
| | 120-139 | mm Hg | 1 |
| | 140-159 | mm Hg | 2 |
| | ≧160 | mm Hg | 3 |
| Diastolic blood pressure | 60-90 | mmHg | 0 |
| | >90 | mm Hg | 2 |
| | <60 | mm Hg | 3 |
| Pulse pressure | <55 | mm Hg | 0 |
| | 55-<65 | mm Hg | 1 |
| | 65-80 | mm Hg | 2 |
| | >80 | mm Hg | 3 |
| Systolic ejection fraction (EF) | ≧55% | | 0 |
| | 45-54% | | 1 |
| | 31-44% | | 2 |
| | ≦30% | | 3 |
| Cardiac index | ≧2.5 | | 0 |
| | 2.0-2.4 | | Not used |
| | <2.0 | | 3 |
| Ascending aorta | <25 | mm | 0 |
| | 25-29 | mm | 1 |
| | 30-49 | mm | 2 |
| | ≧50 | mm | 3 |
| Heart rate | 60-100 | bpm | 0 |
| | <60 | bpm | 1 |
| | >100 | bpm | 2 |
| Pulmonary pressure | ≦35 | mm Hg | 0 |
| | 36-50 | mm Hg | 1 |
| | 51-69 | mm Hg | 2 |
| | ≧70 | mmHg | 3 |
| Superior vena cava flow | No respiratory change | | 0 |
| | Respiratory change | | 1 |
| Deceleration time | 140-240 | ms | 0 |
| | >240 | ms | 1 |
| | 140-240 | ms, | 2 |
| | if e′ <10 and/orLAVI >28 | | |
| | <140 | ms | 3 |
| Mitral valve early velocity/ | 0.75-1.5 | | 0 |
| atrial contraction - E/A | <0.75 | | 1 |
| | 0.75-1.5, if e′ <10 and/or | | 2 |
| | LAVI >28 | | |
| | >1.5 | | 3 |
| Myocardial relaxation | ≧10 | cm/s | 0 |
| velocity-e′ | ≧9-<10 | cm/s | 1 |
| | <9->7 | cm/s | 2 |
| | ≦7 | cm/s | 3 |
| Left atrial volume index | 22 ± 6 | ml/m² | 0 |
| (LAVI) | >28-34 | ml/m² | 1 |
| | >34-<40 | ml/m² | 2 |
| | ≧40 | ml/m² | 3 |
| Pulmonary vein A reversal | <30 | ms | 0 |
| and atrial contraction (PVAR | ≧30 | ms | 1 |
| and A) duration | | | |

| | | |
|---|---|---|
| Filling Presure (E/e′) | 8-14, if e′ ≧10 | 0 |
| | ≧8-<11, if e′ <10 | 1 |
| | ≧11-<15, if e′ <10 | 2 |
| | ≧15, if e′ <10 | 3 |

The exemplary list of features 118 shown in Table I above is not exhaustive and is merely intended as an illustration of one application of the aspects of the disclosed embodiments. It will be understood that the list of features 118 shown in Table I can include other features associated with different medical and physiological conditions. In this example, the list of features 118 in Table I might be considered related to a surrogate disease model for heart failure.

After the medical data 104 is received in the data processing system 108, in one embodiment, the knowledge-base 114 is configured to identify one or more feature sets 116 that have the highest correlation to the features 118 corresponding to the medical data 104. An example of a system to correlate features to feature sets is described in commonly assigned U.S. patent application Ser. No. 12/710,983 filed on Feb. 23, 2010. In this way, the medical data 104 is transformed from the knowledge of characteristics of the medical data 104 to metadata in the form of the group of highly associated features 118 of each of the feature sets 116 in the subset, also referred to as transformed data 136.

As is shown in Table I, each knowledge base validated quantifiable stage 120 is assigned a numerical score 122. The numerical score 122 generally represents a risk level associated with the particular range of values in the validated quantifiable stage 120. The scores 122 are used by associative algorithms 126 stored in or associated with the data processing system 108 shown in FIG. 1, to determine the at-risk medical condition or finding 128 for predicting a medical condition of the patient 106 having a particular combination of medical data 104. The aspects of the disclosed embodiments enable the magnitudes of the medical data 104 to be applied to the features 118 within each selected feature set 116 to determine a cumulative or collective risk that a person whose medical data 104 is analyzed has or does not have a medical condition related to the selected feature set(s) 116.

In one embodiment, the memory 110 stores an associative algorithm 126 for execution by the processor 112 in order to determine a finding 128. The finding 128 generally corresponds to a state of at-risk medical conditions. In one embodiment, the positions of the magnitude of values of the medical data 104 are compared with the ranges of values of quantifiable stages 120, of the highly associated features 118 of feature sets 116. The score 122, also referred to as the intensity of the association level, of the highly associated features 118, is then processed by the algorithm 126 and correlated with a state of at-risk medical conditions, or finding 128. The finding 128 also includes or generates a prediction or output statement 130 corresponding to the at-risk medical condition. The prediction statement 130 can be an indication of structural or physiologic status of the medical data 104, an emergent physiological condition, pre-emergent physiological condition or existing physiologic condition.

The associative algorithm 126 is generally a domain dependent algorithm that is configured to apply the magnitudes of the medical data 104 to the features 118 within each selected feature-set 116 to determine a cumulative or collective risk 124 that a person whose medical data 104 is analyzed has or does not have a medical condition of the selected feature-set(s) 116. The cumulative or collective risk 124, also referred to as the medical risk score, produces a feature-set 116 with single score values rather than the particular, individual units of measured medical data. In one embodiment, a “cumulative” scoring process is applied to the scores 122 corresponding to a particular set of medical data 104. In a cumulative scoring process, the associative algorithm 126 takes advantage of the conversion of the medical data 104 and/or the quantifiable stages 120 of the feature 118 into scores 122 that have no units. This conversion allows for the algorithm 126 to calculate the cumulative score 124 as the cumulative medical risk score. That is, the highly-associated features 118 of the feature set 116 produce a single score value via one or more algorithms 126 without having to be concerned with the particular units of measured medical data 104.

In one embodiment, the cumulative risk 124 is generally expressed as a cumulative numerical value, or score 122, corresponding to the status of the particular medical data 104. In one embodiment, the associative algorithm 126 takes the sum of the scores 122 of the highly-associated features 118 based on the number of quantifiable stages 120 divided by the total sum of the maximum possible scores 122 of the features 118 to calculate the cumulative medical score, which forms the transformed data 124.

For example, consider the medical data 104 resulting from an echocardiography of the exemplary patient 106 as follows:

systolic ejection fraction (EF) of 51%,

surrogate filling pressure (E/e′) of 12 mm Hg,

myocardial relaxation velocity (e′) of 8.5 cm/s, and

left atrial volume index (LAVI) of 29 ml/m².

Referring to the list of features 118 in Table I, a systolic ejection fraction (EF) measurement of 51% falls within the knowledge base validated quantifiable stage 120 range of 45-54%. The score 122 associated with this quantifiable stage 120 is 1, out of a maximum score of 3.

Similarly, a measured value of 12 mm Hg for the surrogate filling pressure (E/e′) feature results in a score 122 of 2, where the maximum score indicated in Table I associated with the filling pressure (E/e′) is 3.

The measured value of 8.5 cm/s for the myocardial relaxation velocity e′ feature has corresponds to a score of 2, where the maximum indicated score is 3.

The measured left atrial volume index of 29 ml/m² corresponds to a score of 1, out of a possible maximum score of 3.

Where the associative algorithm 126 includes a cumulative scoring process, applying the cumulative scoring process to this exemplary echocardiography data for determining, for example, systolic dysfunction, the cumulative medical risk score for the patient 106 above is: (1+2+2+1)/(3+3+3+3)=0.5. Using the data stored in the knowledge-base 114, the system 100 is configured to compare the cumulative medical risk score of 0.5 to a medical standard of the physiological condition and/or risk assessment that is associated with the features-set 116 for systolic function that includes the features 118 from which the scores have been determined for the calculation of the medical risk score. The medical standard includes value ranges for the calculated medical risk score, wherein for example, the score of 0.0 is determined to be normal risk of systolic dysfunction, diastolic dysfunction, secondary atrial fibrillation, atrial pressure overload, and no medical condition(s) may be in the pre-emergent stage. However, for the calculated medical risk score of 0.5 in the above example, the comparison to the medical standard in the knowledge-base 114 results in the determination or finding 128 that the patient 106 has an increased risk of systolic dysfunction, diastolic dysfunction, secondary atrial fibrillation, atrial pressure overload, and several other cardiac medical conditions, which medical condition(s) may be in the pre-emergent stage. Further, the finding 128 may include suggestions for additional diagnoses of the secondary pulmonary hypertension, primary pulmonary hypertension, mixed pulmonary hypertension. In one embodiment, the system 100 can either read or request the input of further medical data 104 related to the additional diagnoses. This could include for example, a request for additional medical data 104 for features 118 such as pulmonary artery pressure and superior vena cava flow, or for hypertensive heart disease, or blood pressure and left ventricle mass.

In one embodiment, the associative algorithm 126 can include a collective set analysis process. In a collective set analysis process, instead of dividing the sum of scores 122 for the features 118 by the sum of the total possible scores to calculate the medical risk score, the medical risk score is a set of the scores 122 of each feature 118 for a feature set 116, considered as a collective set. Consider for example, the two feature sets 116 illustrated below, each having four highly associated features 118. The score 122 corresponding to each validated quantifiable stage 120 of each of feature 118 is determined to be:

| EXAMPLE SET I | EXAMPLE SET II |
|---|---|
| Feature 1; 1 out of 3; | Feature 1; 0 out of 3; |
| Feature 2; 0 out of 4; | Feature 2; 0 out of 4; |
| Feature 3; 0 out of 3 | Feature 3; 0 out of 3 |
| Feature 4; 0 out of 3 | Feature 4; 1 out of 3 |

Using a collective analysis process, the particular combination of scores for different features can provide a different finding 128. Feature 1 in Example Set I, has a score of 1/3, while in Example Set II, Feature 1 has a score of 0/3. Feature 4 in Example Set I has a score of 0/3, while Feature 4 in Example Set II has a score of 1/3. In a collective analysis, the collective set of values defines a profile that is correlated to a specific finding 128. Thus, since the collective scores for each feature 118 in each of the example sets are different, the collective profile for each will be different. Thus, the finding 128 for Example Set I and Example Set II could also be different.

In contrast, applying the cumulative score process described above, generally referred to as algebraic averaging, to Example Set I and Example Set II, results in a medical risk score in each of 1/13. Thus, even though the individual scores are different for certain features, the finding 128 utilizing the cumulative process is the same. The application of the cumulative score process described herein is domain independent, meaning that the technique can be applied to numerous types of data sets in any number of clinical settings. These can include data acquisition, such as echocardiography, and MR; specialty, such as cardiology, neurology, pulmonology; and condition, such as emergent, pre-emergent, and ongoing disease state.

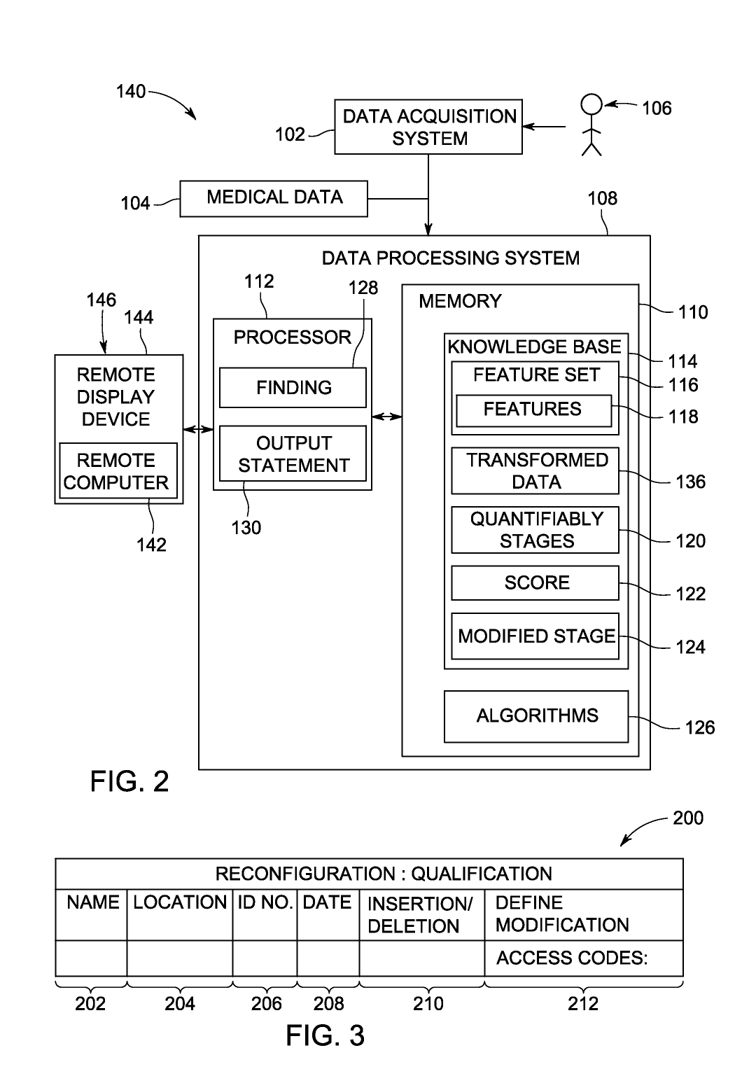

FIG. 2 illustrates another example of a medical finding prediction system 140 incorporating aspect of the disclosed embodiments. In this example, the user interface is or includes a remote user interface 142 on a remote display device 144 of a remote computer 146 that is in communication with the data processing system 108 of the disclosed embodiments.

The aspects of the disclosed embodiments provide for reconfiguring aspects of the knowledge base 114 and findings 128 in the medical finding prediction system 100. Clinicians are able to reconfigure key inputs and outputs of the medical finding prediction system's knowledge-based algorithms without adversely affecting attributes or the power of the decision-making processes. This can include for example, changing or reconfiguring values in the quantifiable stages 120 and changing output statements 130 associated with medical findings 128.

Referring to FIG. 3, one embodiment of an exemplary access screen 200 for assuring the qualifications of a user using the medical finding prediction system 100 of the disclosed embodiments is illustrated. A “user” as that term is used herein, refers to, for example, a physician, nurse or medical technologist or technician, generally referred to as a “clinician” herein. In one embodiment, the access screen 200 is presented on the user interface 134 shown in FIG. 1. The access screen 200 provides the user of the system 100 secure access for dynamically reconfiguring aspects of the knowledge base 114 of the data processing system 108 as is further described herein. In one embodiment, the access screen 200 includes data fields for entering user identification and verification data, including for example, but not limited to, Name 202, Location 204, ID Number 206, Date 208, Insertion or Deletion selector 210, and Modification Access Code 212. The Modification Access Code 212 is used for security purposes of providing limited access to the knowledge-base 114, tracking the identity of the user configuring the knowledge-base 114, and/or tracking for whom or what entity the user configured knowledge-base 114 is applicable. The aspects of the disclosed embodiments provide that if changes are made first, the changes will not affect the finding 128, as determined by the cumulative data analysis or collective profile analysis in the associative algorithm, but rather only affect the user's preference in expressing the finding 128 in the output statement 130.

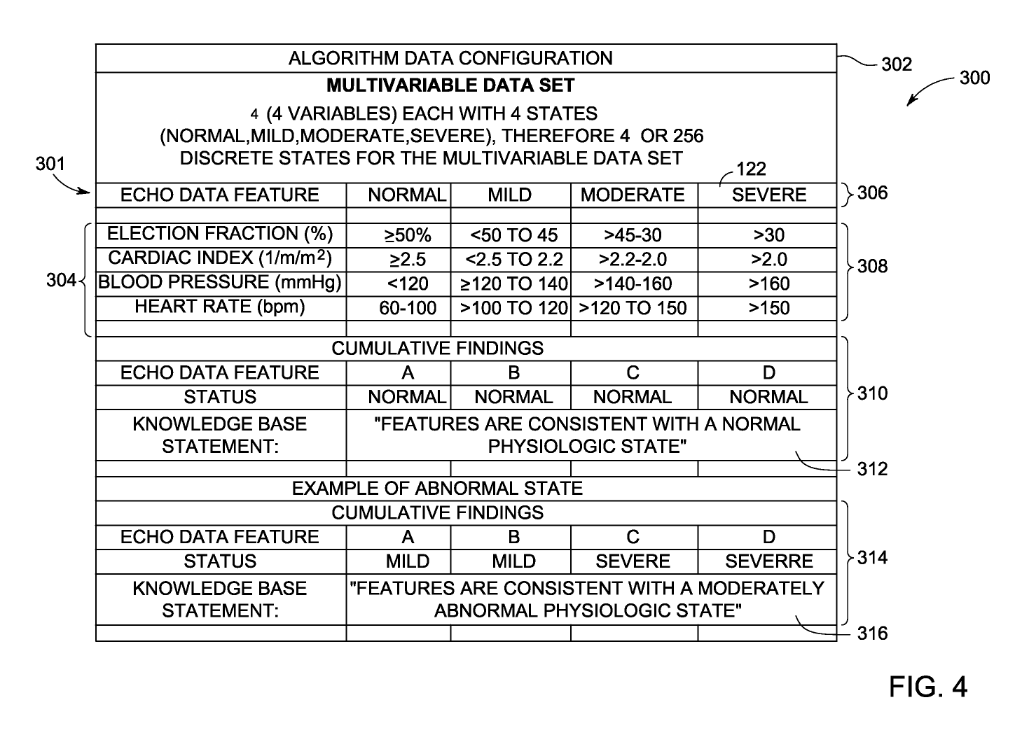

FIG. 4 illustrates an exemplary user interface screen 300 for user directed dynamic configuration of a multivariable data set and associated statements for the data set that can be used in the medical finding prediction system 100. The screen 300 is an example for configuring the knowledge-base 114 to local and/or personalized standards. Personalized standards mean standards as determined by the clinician for a specific individual patient 106 and/or a group of patients, general and/or specific.

The user interface screen 300 shows a data configuration 302 for a multivariable data set 304. In this example, the data set 304 includes four features 118 from Table 1, where the data set generally corresponds to a feature set 116 referred to in FIG. 1. In this example, the data set 304 is for an “echo data feature” 301. Although the data set 304 only includes four features 118 in this example, in alternate embodiments, the data set 304 can include any number of features 118, including more or less than four.

In the example shown in FIG. 4, each feature 118 in the data set 304 is associated with a set 306 of scores 122. In this example, the scores 122 shown on the screen 300 are textual rather than numeric. In the embodiment shown in FIG. 4, for ease of understanding and user friendliness, the system 100 is configured to provide terminology or text associated with each of the four states 306. Behind the screen 300, the software and hardware of the system 100 can be configured to associate numerical scores with each of the states 306, such as the numerical scores 122 illustrated in Table I. In the example of FIG. 4, the set 306 of scores 122 includes a “Normal”, “Mild”, “Moderate” and “Severe” score, also referred to as a “state.” Although only four scores are shown in the set 306, in alternate embodiments, any suitable number of scores or states can be included in the set 306.

Each score within the set 306 is associated with a respective validated quantifiable stage 120, referred to in this example as quantifiable stage set 308. In the embodiment shown in FIG. 3, the quantifiable stage set 308 is configurable by the user. The aspects of the disclosed embodiments allow the user to change the numerical values for a quantifiable stage 120 without affecting the computing processes. Thus, the user has a certain amount of control to implement modifications without affecting the actual processing of the medical data 104.

When a set of medical data 104 is inputted or received into the system 100, the system 100 is configured to evaluate the medical data 104 and determine one or more findings 128 and generate one or more output statements 130. The output statement 130 in this example of FIG. 4 is referred to as knowledge base statement 312. The aspects of the disclosed embodiments are configured to provide a knowledge base statement 312 to the clinician that provides an indication or summary of the medical finding 128, also referred to as a prediction. The screen 300 includes a cumulative findings section 310 that includes the knowledge base statement 312. In this example, the cumulative findings section 310 indicates and validates that the findings 128 fall within “normal” ranges. The corresponding knowledge base statement 312 also indicates and validates that the medical data 104 is within a normal range for the particular patient 106. In this example, the findings 128 are based on the cumulative score process described herein.

For purposes of illustration, the screen 300 shown in FIG. 4 also shows what the cumulative findings section 310 would look like if the medical data 104 evaluated is determined to be abnormal. Exemplary section 314 shows such an “abnormal” finding 128, which also includes a knowledge base statement 316 associated with the “abnormal state” finding 128.

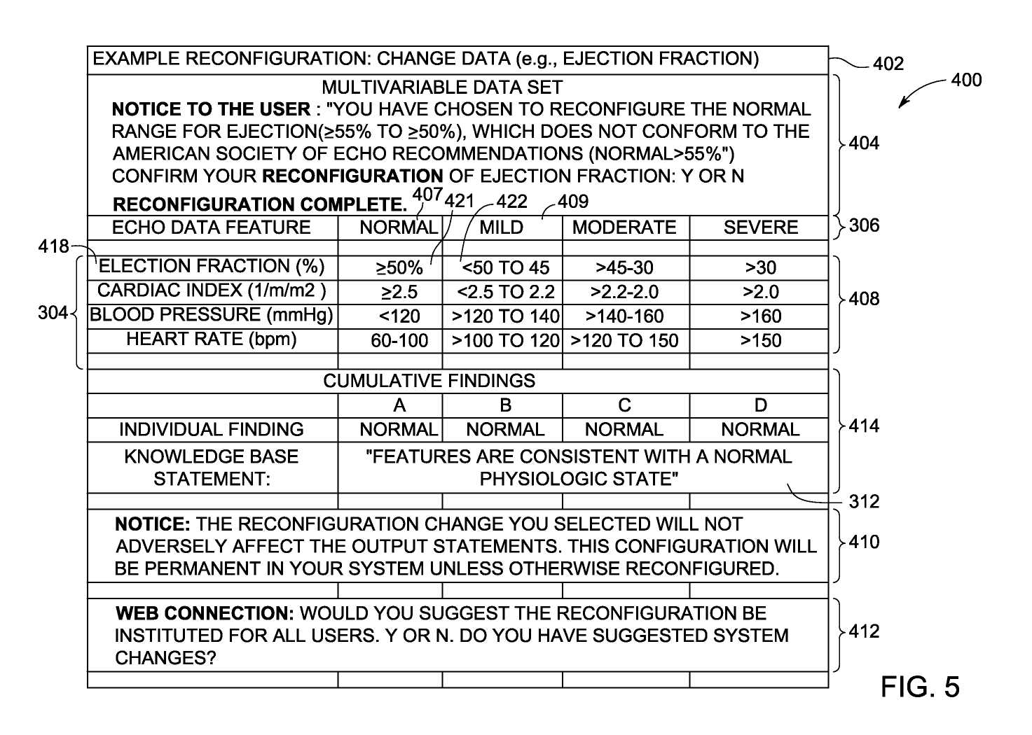

The aspects of the disclosed embodiments allow the user of the system 100 to reconfigure the parameters for one or more of the quantifiable stages 120 as well as the output prediction statements 130 that correspond with a particular finding 128. FIG. 5 shows an exemplary user interface screen 400 illustrating a set 408 of quantifiable stages 120 that has been modified or reconfigured. In this example, the individual quantifiable stages 421 and 422 of the set 408 corresponding to the ejection fraction feature referenced as 418 in this example have been modified from the values present in screen 300 of FIG. 4. Although only two of the quantifiable stages 120 in the set 408 are modified, in alternate embodiments, any desired number of quantifiable stages 120 can be modified. As is shown on the screen 400, the quantifiable stage 421 corresponding to the “Normal” state 407 has been changed from “≧55%” shown in FIG. 4 to “≧50%.” The quantifiable stage 422 associated with the “Mild” state 409 has been modified from “<55 to 45%” shown in FIG. 4 to “<50 to 45%” in FIG. 5.

In the embodiment illustrated in FIG. 5, a notice 404 to the user is provided for the specific change or reconfiguration, which in one embodiment can require confirmation of the intended reconfiguration. A notice 410 is provided on the user interface screen 400 that informs the user that the changes to the data set 304 will not affect the output statements 130 associated with findings 128, such as the output statement 312 shown in the cumulative findings section 414. The notice 410 can also inform the user that the change will be permanent to the system 100. A notice 412 can also be provided, referred to herein as a network or web connection 412 notice, which allows the user to confirm whether the reconfiguration to the knowledge base 114 should be automatically propagated to all other users of the system 100.

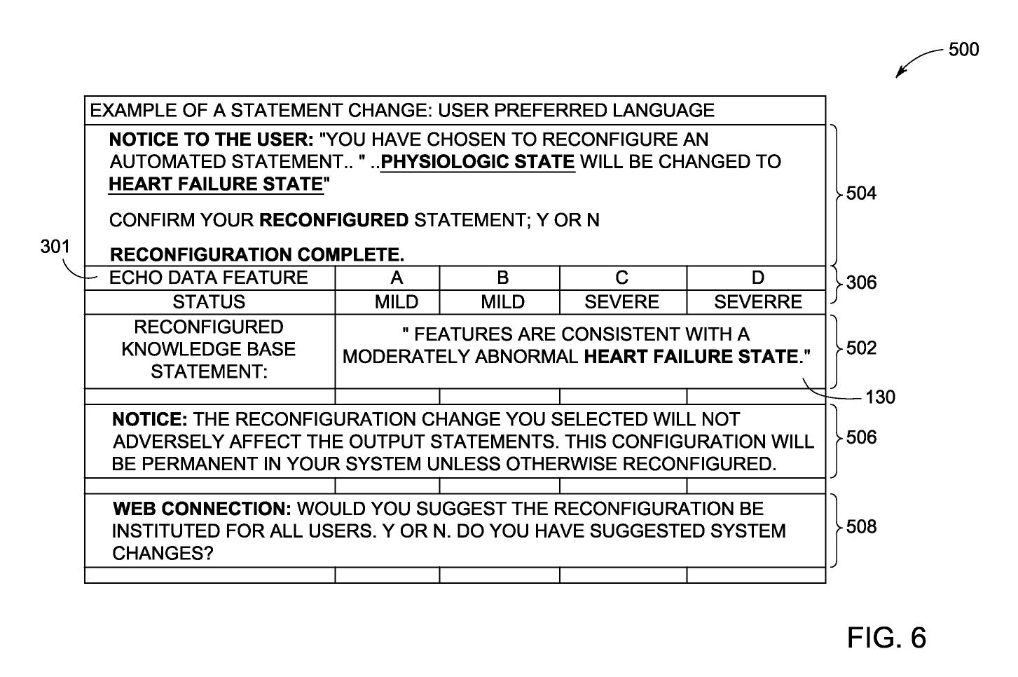

FIG. 6 illustrates the modification of an automated prediction or output statement 130 associated with a medical finding 128 in a system 100 incorporating aspects of the disclosed embodiments. The knowledge base 114 will generally include one or more automated output statements 130 that provide an indication to the user of a particular correlation of finding 128 to a particular medical condition or state. Referring to the example shown in FIG. 4, the knowledge base statement 312 reflects a finding 128 that is considered to be consistent with a “normal physiologic state”, and thus the output statement 312 in this example recites “Features are consistent with a normal physiologic state.” However, in certain situations, it may be desired to tailor or customize the output statements 130 to be specific to a feature set 116 or finding 128. For example, when dealing with a feature-set 116 related to heart failure, it may be desirable to tailor the output statement 130 associated with such a finding 128 related to this particular feature set 116 to reflect the particular predicted “heart failure state.” The aspects of the disclosed embodiments allow a user to change or reconfigure any one of the automated output statements 130 that are stored in the knowledge base 114.

In this example, the exemplary user interface screen 500, which can be associated with the display 132 and user interface 134 of FIG. 1, illustrates the modification of an output statement 130. In the example shown in FIG. 5, the output statement 130 for the finding 128 related to the echo data feature set 301 refers to “physiologic” state As is shown in FIG. 6, the output statement 130 corresponding to the echo data feature set 301 has been modified to change the term “physiologic” to “heart failure.” The reconfigured knowledge base statement 502 states “Features are consistent with a moderately abnormal heart failure state.”

In the example of FIG. 6, a notice 504 is provided to the user that indicated the reconfigured statement change and allows the user to affirmatively confirm the change. Selection of “yes” or “Y” in the example shown will complete the reconfiguration. The notice 506 informs the user that the change will be permanent to the knowledge base 114. A network or web connection 508 notice can also be provided asking the user whether the reconfiguration to the knowledge base 114 should be propagated to all users.

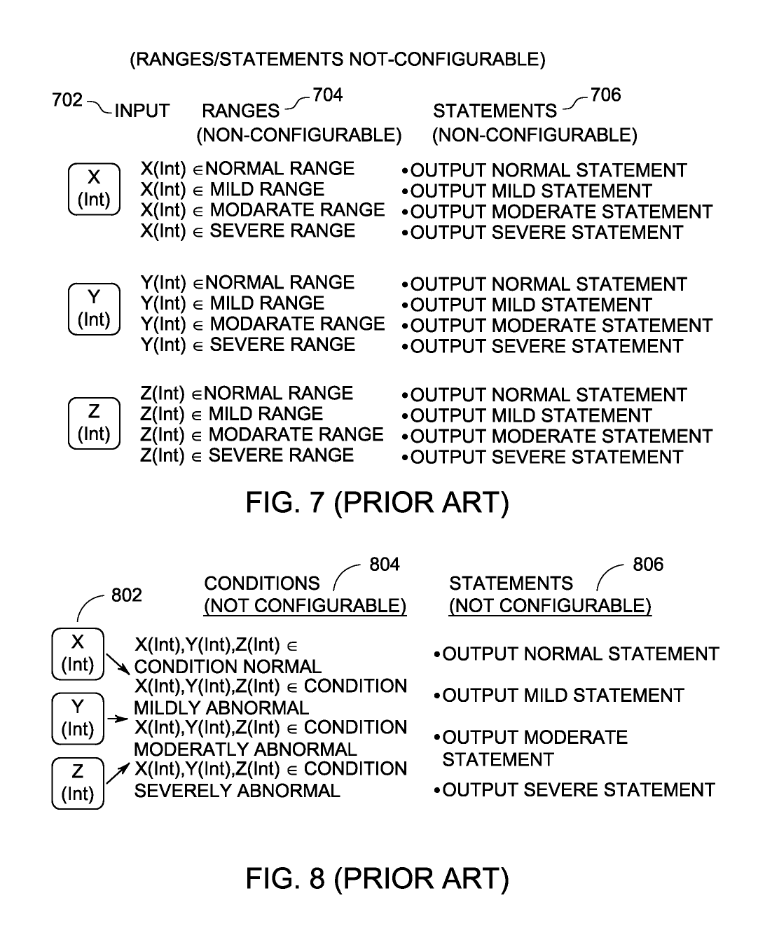

FIGS. 7 and 8 illustrate examples of exemplary non-configurable clinical algorithmic programming models or function statements of the prior art. Inputs 702, shown as X(int), Y(int), Z(int), represent variables for which a user may input a value (number). The values can be the medical data 104 described with respect to FIG. 1. Preset guidelines establish normal cut off values and ranges for abnormal values. The ranges 704 generally corresponding to the validated quantifiable stages 120 described with respect to FIG. 1. The programming provides logical conditions, indicated as ranges 704, such that if a particular variable falls within a defined range, a corresponding logical output statement 706 is generated. The output statement 706 generally corresponds to a finding 128 and output statement 130.

The ranges 704 shown in FIG. 7 are predetermined ranges for each variable input 702 that are associated with standards and score value statements. For example, referring to the “Ejection Fraction” variable of features 118 shown in Table 1, the following statements can be made:

If x≧55%, the output statement 706 is “normal”;

If x=45-54%, the output statement 706 is “mildly abnormal”;

If x=31-44%, the output statement 706 is “moderately abnormal”; and

If x≦30, the output statement 706 is “severely abnormal.”

When an input value of 52% is entered for x, the algorithm determines that the value is within the standard or state associated with the “mildly abnormal” score value statement 706. The predetermined statement “mildly abnormal” is correspondingly outputted.

FIG. 8 illustrates a model whereby multiple input variable integers 802 are applied to multi-variable condition sets 804 resulting in logical outputs 806 that correspond to defined integer values for that variable conditions set.

Each of the predetermined ranges statements 806 for x, y, and z is associated with conditions 804 for the multivariable collective set processes. For example, consider the range and range description assignments below:

x<=28, the output is “normal”;

x=28-33, the output is “mildly abnormal”;

y>=10, the output is “normal”;

y=9-10, the output is “mildly abnormal”;

z<8, the output is “normal”;

z=7-8, the output is “mildly abnormal.”

The conditions and assigned descriptions of score value statements are:

if x<=28, y>=10, z<8, output “normal condition”;

if x=28-33, y=9-10, z=7-8, output “mild condition.”

Thus, if the input values of x=29, y=10, z=8 are entered, the collective set process program determines that these values meet the conditions of x=28-33, y=9-10, and z=7-8. The predetermined score value statement associated with this standard based on the assignments above is “mild condition.” The program then outputs a predetermined statement, such as for example, “represents mildly abnormal disease.”

If a particular user of the algorithm for FIG. 8 desires to alter the normal value for x (<=28), the condition “if x<=28, y>=10, z<8, normal condition” in the algorithm itself has to be altered. In both logic models shown in FIGS. 7 and 8, the ranges 704, conditions 804 and output statements 706, 806 are not configurable.

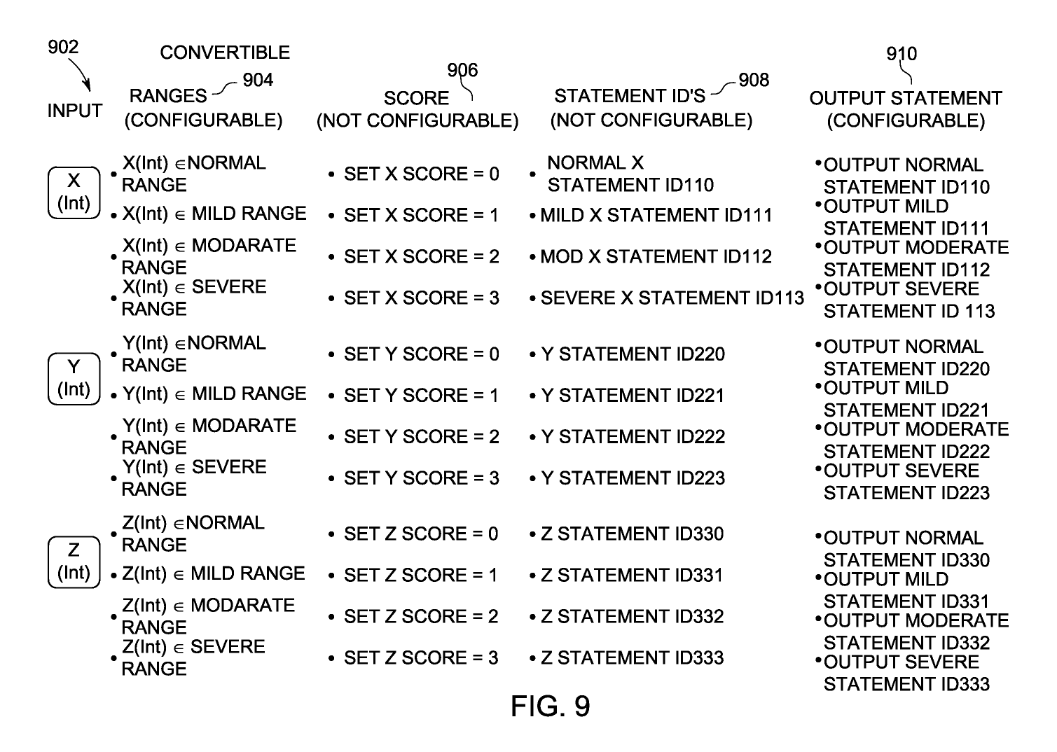

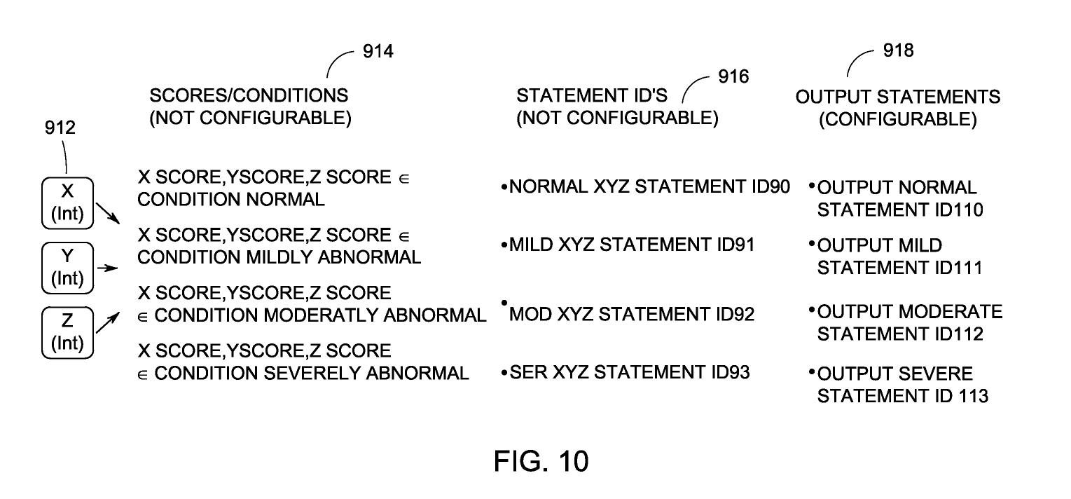

FIGS. 9 and 10 show examples of dynamically configurable clinical programming models that can be implemented in the medical finding prediction system 100 of the disclosed embodiments. In this example, the input variables 902, shown as X(int), Y(int) and Z(int) represent variables for which a user may input a value (number). In this example, the input values are medical data 104. Scientifically published and accepted guidelines establish normal cut off values and ranges for abnormal values. However, because much of medicine is opinion and based on a particular practitioner or practice's experience, not all practitioners may adhere to the published and accepted guidelines. In some cases, there can be use of practice-specific standards for some variables.

FIG. 9 shows a configurable clinical “layered” programming model wherein ranges 904 can be assigned a weighted score. In this example, the weighted score ranges from normal to severe. In alternate embodiments, any suitable weighted score range can be used. Each variable X(int), Y(int) and Z(int) is associated with a range 904, score 906, statement ID 908 and output statement 910. Much of medicine is semantically driven with preferential use of descriptors in interpretation statements. In one embodiment, the output statements 910 are catalogued with a unique statement identifier 906 and default wording or text that can be edited. Applying the statement identifier 906 to the output statements 910 as opposed to the algorithm generating the statements themselves, allows for consistent logic to be applied to configurable output statements.

In FIG. 9, there are preset standards for each input variable 902 and the associated scores 906. In accordance with the aspects of the disclosed embodiments, the user can modify the quantifiable stage or ranges 904 for each input variable 902. For example, referring back to the systolic ejection fraction feature of Table 1, the quantifiable stages or ranges and assigned scores can be modified. For example:

For x≧55%, x score=0, the quantifiable stage value is reconfigured by the user to be x>60;

For x in the range of 45-54%, x score=1 the quantifiable stage value is reconfigured by the user to be 45-59%;

For x in the range of 31-44%, x score=2 the quantifiable stage value is not reconfigured by user;

For x≦30, x score=3 the quantifiable stage value is not reconfigured by user.

The scores with assigned range description assignments are set to be:

For an x score=0, the range description or output statement 910 is established as “normal”;

For an x score=1, the output statement 910 is “mildly abnormal”;

For an x score=2, the output statement 910 is “moderately abnormal”;

For an x score=3, the output statement 905 is “severely abnormal.”

When an input value of x=56 is entered, the program uses the standard ranges set by the user instead of the default standards. Accordingly, an input value of x=56 is determined not to be “normal” based on the score of 0 based on the default standard. In this example, the input value of x=56 is determined to have the score of 1 and corresponds to the finding 128 and corresponding output statement 905 of “mildly abnormal.”

FIG. 10 illustrates a model whereby input variable scores 914 are applied to multi-variable feature-sets 912 (in this example X(int), Y(int) and Z(int)) resulting in logical outputs 918 that correspond to the defined scores/conditions 906 from FIG. 9 for that feature-set. The output statements 918 shown in FIG. 10 have unique identifiers (statement ID's) 916 with text that can be edited or reconfigured, as is described herein. In both of the models shown in FIGS. 9 and 10, the quantifiable stages or ranges 904 and output statements 910, 918 are dynamically configurable and can be changed with a consistent logical output result.

The aspects of the disclosed embodiments allow the user to modify the standards for the variables x, y and z from the preset standards as well as their associated scores. In the example of FIGS. 9 and 10, the following range 904, assigned score 906 and range description assignments 910 for inputs 902 are as follows:

x<=28, x score=0, the output statement 910 is “normal”;

x=28-33, x score=1, the output statement 910 is “mildly abnormal”;

y>=10, y score=0, the output statement 910 is “normal”;

y=9-10, y score=1, the output statement 910 is “mildly abnormal

z<8, z score=0, the output statement 910 is “normal”;

z=7-8, z score=1, the output statement 910 is “mildly abnormal”;

The conditions 914 and assigned output statements 918 for the multivariable input 912 are:

if x score=0, y score=0, z score=0, the output statement 918 is “normal condition”;

if x score=1, y score=1, z score=1, the output statement 918 is “mild abnormal condition.”

Thus, when input values 902, representing medical data 104, of x=29, y=10, and z=8 are entered or received, the corresponding scores 906 are determined to be x score=1, y score=1, and z score=1. Using a collective set process, the condition xscore, yscore, zscore meets the standard condition of “moderately abnormal disease.” However, in the example of FIG. 10, the user has personalized the knowledge-base 114 by modifying the output statement 918 that meets the above condition to “mildly abnormal disease.” Thus, the finding of “mildly abnormal disease” is outputted.

If a particular user of the system 100 wanted to alter the normal value for x (<=28), the system 100 allows the user to alter this cutoff value without altering the condition in the algorithm “if xscore=0, yscore=0, zscore=0, normal condition.” Therefore, in the model shown in FIGS. 9 and 10, the range 904 can be modified or changed without the need to modify the logic in the algorithm itself.

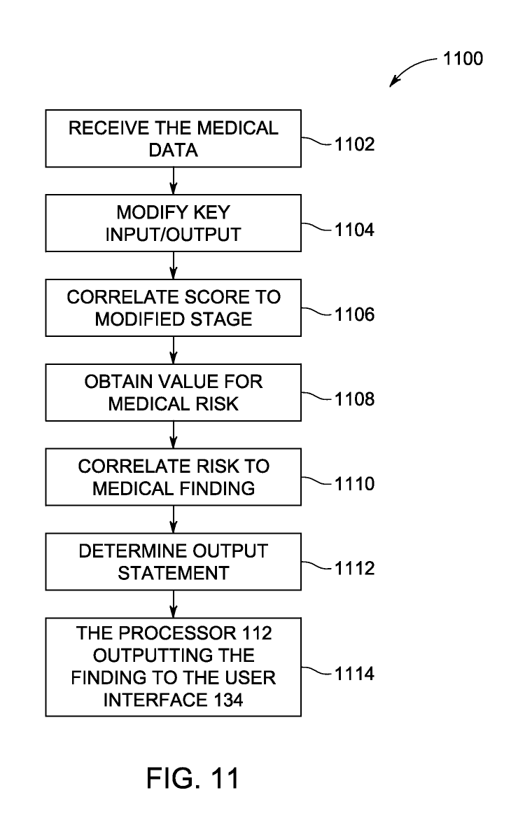

FIG. 11 shows a flow diagram of an exemplary method 1100 for determining a finding 128 and/or a prediction with respect to the individual's physiological condition based on the individual's medical data 104. In this example, the method 1100 is a computer based knowledge-based prediction method and includes dynamically configuring a quantifiable stage 120 assigned to a feature 118 of a feature-set 116 that is highly-associated with an emerging or pre-emergent physiological condition and/or a disease state. In one embodiment, the method includes an individualized transformation of medical data 104.

The aspects of the disclosed embodiments and method 1100 are typically implemented on a medical system 100 having a medical data acquisition tool 102 for obtaining medical data 104 of a person 106. In one embodiment, the processor 112 described with respect to FIG. 1, is configured to execute the method 1100. In one embodiment, medical data 104 is received 1102 in the data processing system 108. One or more of the key inputs to the associated algorithms and/or output statements are modified 1104. A score 122 is correlated 1106 to the modified stage 124. A medical risk value is obtained 1108 for the medical data 104. The medical risk value is correlated 1110 a medical finding 128 with respect to the physiological condition. The medical finding 128 is correlated 1112 with an output or prediction statement 130. The finding 128 is outputted 1114 to the clinician via the user interface 134.

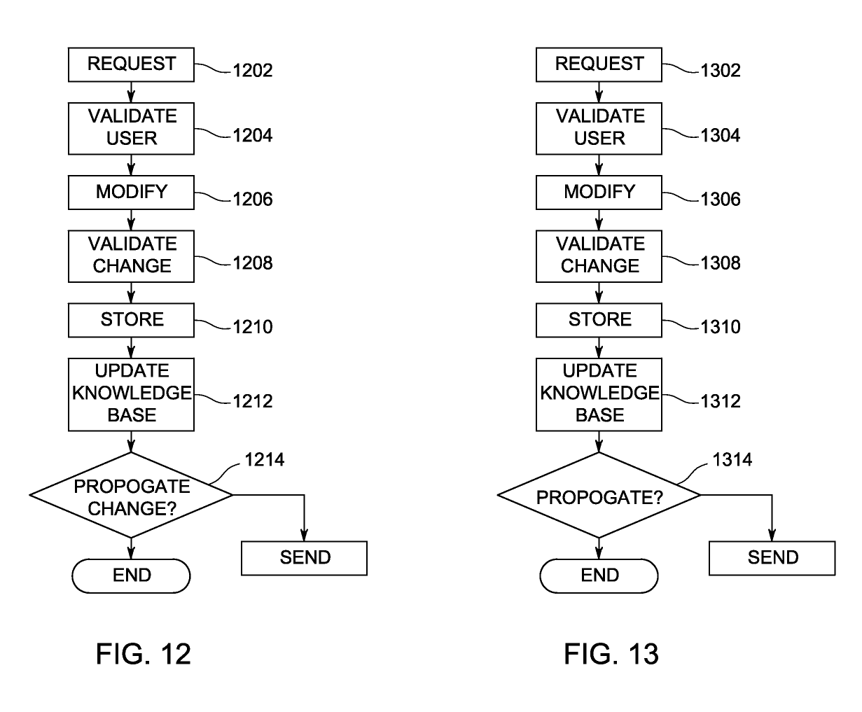

FIG. 12 illustrates one embodiment of a method of modifying a key input, which in this example is a validated quantifiable stage 120. In one embodiment, the system 100 detects 1202 a request to modify a validated quantifiable stage 120. The credentials of the user making the request are validated 1204. In one embodiment, this can include the user entering a user name and password via the user interface 132. Once the user is validated, the user can proceed to modify 1206 one or more of the quantifiable stages. In one embodiment, the modifications are validated 1208 against data stored in the knowledge based 114 to ensure that the modifications are reasonable with respect to the particular features 118 and feature sets 116. If the changes are validated 1208, the modifications are stored 1210 and the knowledge base updated 1212. In one embodiment, the modifications are stored for a specific patient analysis. However, the user can be presented with the option 1214 to propagate the changes to all users of the system 100.

FIG. 13 illustrates one embodiment of a method of modifying a key output, which in this example is an output statement 130. In one embodiment, the system 100 detects 1302 a request to modify an output statement 130. The credentials of the user making the request are validated 1304. In one embodiment, this can include the user entering a user name and password via the user interface 132. Once the user is validated, the user can proceed to modify 1306 one or more of the output statements 130. In one embodiment, the modifications are validated 1308 against data stored in the knowledge based 114 to ensure that the modifications are reasonable with respect to the particular features 118, feature sets 116 and medical findings 128. If the changes are validated 1308, the modifications are stored 1310 and the knowledge base updated 1312. In one embodiment, the modifications are stored for a specific patient analysis. However, the user can be presented with the option 1314 to propagate the changes to all users of the system 100.

The system 100 is generally configured to utilize program storage devices embodying machine-readable program source code that is adapted to cause the apparatus to perform and execute the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

The system 100, including the data processing system 108 and processor 112 may also include one or more processors for executing stored programs, and each may include a data storage or memory device on its program storage device for the storage of information and data. The computer program code, software or computer-readable storage medium incorporating the processes and method steps incorporating aspects of the disclosed embodiments may be stored in one or more computer systems or on an otherwise conventional program storage device. In one embodiment, the computer-readable storage medium is a non-transitory computer-readable storage medium.

The aspects of the disclosed embodiments provide for a configurable or reconfigurable medical finding prediction system that is user friendly and allows the user to control the output. Key inputs and outputs of the medical finding prediction system's knowledge-based algorithms can be reconfigured. This includes the validated quantifiable stage values and ranges associated with the features as well as the output statements corresponding to medical findings. The system tolerates user change with respect to the input values and output expressions without adversely affecting the overall function of the CDSS decision making process and assures the user's dominant role in the decision making processes.

Thus, while there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A reconfigurable medical decision support system for processing medical data of a patient, the system comprising:
a data processing system with a memory in communication with a processor, the memory including program instructions for execution by the processor to:
receive the medical data;
access a knowledge-base data set stored therein, the knowledge-base including a feature set relating to a pathophysiological condition, the feature set having a plurality of associated features, each feature having a plurality of validated quantifiable stages and each validated quantifiable stage being assigned a score;
associate the medical data with features of the feature-set;
detect a request to modify a value of a validated quantifiable stage associated with a feature;
verify the request and modify the validated quantifiable stage to create a modified validated quantifiable stage;
associate the score from the validated quantifiable stage with the modified validated quantifiable stage;
determine a medical risk value based on the modified validated quantifiable stage and the assigned score;
determine a medical finding from the knowledge base corresponding to the medical risk value;
associate an output statement stored in the knowledge-base with the medical finding; and
a user interface for providing the output statement.

2. The system of claim 1, wherein the memory further includes program instructions for execution by the processor to:
detect a request to change an output statement stored in the knowledge-base;
verify the request;
modify the output statement based on the request; and
update the knowledge-base with the modified output statement.

3. The system of claim 1, wherein the memory further includes program instructions for execution by the processor to:
determine the medical finding by calculating a single medical risk value from an aggregate of scores corresponding to each of the features within the feature set.

4. The system of claim 3, wherein the memory further includes program instructions for execution by the processor to determine the medical risk value by dividing an algebraic sum of a total of all scores for each of the features by a sum of a maximum score associated with each feature.

5. The system of claim 1, wherein the memory further includes program instructions for execution by the processor to:
determine the medical risk value by a collective assessment of each score associated with each of the features.

6. The system of claim 5, wherein the memory further includes program instructions for execution by the processor to:
determine the medical risk value by applying multivariable condition statements from a set of multivariable condition statements to the assigned scores for each feature in the feature-set; and
identify a score associated with a satisfied multivariable condition statement as the medical risk value.

7. The system of claim 6, wherein the memory further includes program instructions for execution by the processor to:
determine a output statement identifier associated with the satisfied multivariable condition statement; and
provide the output statement that corresponds to the output statement identifier.

8. The system of claim 1, wherein the memory further includes program instructions for execution by the processor to determine the medical risk score by:
applying the score associated with each validated quantifiable stage to a range statement in a set of range statements;
identifying a satisfied range statement; and
identifying a score associated with a satisfied range statement as the medical risk value for the quantifiable stage.

9. The system of claim 8, wherein the memory further includes program instructions for execution by the processor to determine the output statement associated with the medical finding by:
identifying a statement identifier associated with the determined medical finding; and
providing an output statement associated with the statement identifier as the output statement associated with the medical finding.

10. The system of claim 1, further comprising a data acquisition system communicatively coupled to the data processing system, the data acquisition system configured to receive medical data of a patient and provide the medical data to the data processing system.

11. The system of claim 1, wherein the medical data acquisition system comprises a medical data diagnostic device.

12. A computer program product, comprising:
computer readable program code means for evaluating medical data of a person to determine a medical finding, the computer readable program code means when executed in a processor device, being configured to:
obtain the medical data of the person;
access a medical knowledge-base data set stored in a memory, the knowledge-base including a feature set relating to a pathophysiological condition, the feature set having a plurality of associated features, each feature having a plurality of validated quantifiable stages and each validated quantifiable stage being assigned a score;
enable a user to reconfigure a value associated with a validated quantifiable stage associated with a feature;
associate the medical data with features of a feature-set from the knowledge-base;
determine an association between the medical data and the quantifiable stages associated with the feature corresponding to the medical data;
determine scores corresponding to the association of the medical data and quantifiable stages;
determine a medical risk value based on the scores corresponding to the association of the medical data and quantifiable stages;
determine a medical finding from the knowledge-base corresponding to the medical risk value; and
provide an output statement corresponding to the medical finding.

13. The computer program product of claim 12, wherein the computer program code means when executed in the processor device for enabling the user to reconfigure a value associated with a validated quantifiable stage associated with a feature is further configured to:
detect a request to change a value of a validated quantifiable stage;
verify an authenticity of the request;
modify the value of the validated quantifiable stage to create a modified validated quantifiable stage value;
associate the score for the validated quantifiable stage value to the modified validated quantifiable stage; and
process the medical data using the modified validated quantifiable stage value.

14. The computer program product of claim 12, wherein the computer program code means when executed in the processor device is further configured to:
detect a request to change an output statement corresponding to a medical finding;
verify the request;
modifying the requested output statement to create a reconfigured output statement; and
associate the reconfigured output statement with the corresponding medical finding in the knowledge-base.
